(19) United States
(12) Patent Application Publication
(10) Pub. No.: US 2026/0327463 A1
(43) Pub. Date: Oct. 22, 2026

(54) SILVER PARTICLES

(71) Applicant: OSAKA SODA CO., LTD., Osaka-shi, Osaka (JP)

(72) Inventors: Masatoshi OKUDA, Osaka-shi (JP); Takamichi MORI, Osaka-shi (JP); Ryo KATOU, Osaka-shi (JP); Daisuke TOMOTOSHI, Osaka-shi (JP)

(73) Assignee: OSAKA SODA CO., LTD., Osaka-shi, Osaka (JP)

(21) Appl. No.: 19/114,035

(22) PCT Filed: Aug. 23, 2023
(86) PCT No.: PCT/JP2023/030335

§ 371 Date: Mar. 21, 2025

(30) Foreign Application Priority Data
Sep. 30, 2022 (JP) 2022-158528

(51) Int. Cl. C09J 11/04; C01G 5/00

(52) U.S. Cl. CPC C09J 11/04; C01G 5/00; C01P 2004/62; C01P 2004/64; C01P 2006/40

(57) ABSTRACT

There is provided a conductive adhesive comprising silver particles dispersed in a solvent, the silver particles having good flowability, and excellent shape stability after being applied to a member and before being sintered. Silver particles dispersed in a solvent, in which an amine compound is adhered to a surface of the silver particles, and when a concentration of the silver particles in the solvent is 50% by mass, a value of SPAN as measured by a photocentrifuge method under predetermined conditions is 0.1 or more and 3.3 or less: SPAN: (V90−V10)/V50 Equation (1), wherein when a sedimentation velocity is expressed by a cumulative distribution, V10 is the sedimentation velocity at a cumulative value of 10%; V90 is the sedimentation velocity at a cumulative value of 90%; and V50 (median sedimentation velocity) is the sedimentation velocity at a cumulative value of 50%.

### TECHNICAL FIELD

The present invention relates to silver particles, a conductive adhesive, a sintered body of the conductive adhesive, and an electronic part comprising the sintered body between members.

### BACKGROUND ART

Conductive adhesives, such as die-bonding agents, are bonding materials used in electronic parts such as semiconductors, LEDs, and power semiconductors. A commonly known bonding method involves bonding such a bonding material to a substrate, by bonding with pressure and heat, or by sintering with heat or the like without pressure. Bonding materials for the pressureless method are recently being developed, from the viewpoint of the efficiency and simplicity of the production process.

Conductive adhesives containing silver particles are recently being developed. Silver particles have the property of being easily sintered by a heat treatment at low temperature in a short period of time. Patent Literature 1, for example, discloses a metal paste obtained by kneading solids composed of silver particles and a solvent, wherein the solids are composed of silver particles including 30% or more of silver particles with particle diameters of 100 to 200 nm on the basis of the number of particles, and an amine compound containing a total of 4 to 8 carbon atoms is bound as a protective agent to the silver particles constituting the solids. According to Patent Literature 1, this metal paste allows sintering of the silver particles at a temperature in a low-temperature range and is also capable of forming a sintered body having low resistance or a sintered body having excellent thermal conductivity.

### CITATION LIST

### Patent Literature

Patent Literature 1: JP 2015-159096 A

### SUMMARY OF INVENTION

### Technical Problem

A conductive adhesive containing silver particles is a dispersion of silver particles in a solvent, and can be applied to the surface of a member (such as a substrate, a semiconductor chip, or the like used in an electronic part) and sintered to achieve bonding between members.

Such a conductive adhesive is desired to have good flowability because it is applied to the surface of a member using a dispenser or the like.

Furthermore, from the viewpoint of, for example, bonding members with high precision, the conductive adhesive is desired to have excellent shape stability after being applied to a member and before being sintered.

It is a main object of the present invention to provide a conductive adhesive comprising silver particles dispersed in a solvent, the silver particles having good flowability, and excellent shape stability after being applied to a member and before being sintered. It is another object of the present invention to provide a conductive adhesive comprising the silver particles, a sintered body of the conductive adhesive, and an electronic part comprising the sintered body between members.

### Solution to Problem

The present inventors have conducted extensive research to solve the aforementioned problem. Specifically, the present inventors have focused on the particle size distribution of secondary particles of silver particles dispersed in a solvent, which has not heretofore been studied for silver particles. Consequently, the present inventors have made the novel finding that when a value of SPAN: (V90−V10)/V50, as measured by a photocentrifuge method under predetermined conditions, is adjusted in a specific range for silver particles dispersed in a solvent, the silver particles achieve both good flowability and shape stability as described above. The present invention has been completed as a result of further research based on this finding.

In summary, the present invention provides the following aspects of the invention:

Item 1. Silver particles dispersed in a solvent, in which
an amine compound is adhered to a surface of the silver particles, and
when a concentration of the silver particles in the solvent is 50% by mass, a value of SPAN as measured by a photocentrifuge method under the following conditions is 0.1 or more and 3.3 or less:

SPAN: (V90−V10)/V50 Equation (1)
wherein when a sedimentation velocity is expressed by a cumulative distribution,
V10 is the sedimentation velocity at a cumulative value of 10%;
V90 is the sedimentation velocity at a cumulative value of 90%; and
V50 (median sedimentation velocity) is the sedimentation velocity at a cumulative value of 50%;
(Measurement Conditions for SPAN)
a measurement sample in which the concentration of the silver particles in the solvent is 50% by mass is prepared; a solvent having an octanol/water partition coefficient (Log Pow) of −2 or more and 4 or less is used as the solvent of the measurement sample; a glass cell (a glass cell with an optical path length of 2 mm) is charged with 0.2 ml of the measurement sample; under a temperature condition of 25 °C, the glass cell is rotated at a low speed at a centrifugal acceleration of 130 G, and data for 500 points are obtained at an interval of 5 seconds, and then the glass cell is rotated at a high speed at a centrifugal acceleration of 1160 G, and data for 500 points are obtained at an interval of 5 seconds; three points between a gas-liquid interface (the liquid surface of the measurement sample) and a solid-liquid interface (the interface between sedimented silver particles and the solvent) of the measurement sample are arbitrarily selected, and each of the three points is analyzed at a node width of 1 mm; each of the sedimentation velocities V90, V10, and V50 is determined from a moving distance of the particles and a time required for the movement, and the SPAN is calculated based on Equation (1).

Item 2. The silver particles according to item 1, wherein the silver particles have an average particle diameter of 50 to 600 nm.

Item 3. A silver particle dispersion comprising silver particles dispersed in a solvent, in which
an amine compound is adhered to a surface of the silver particles, and
when a concentration of the silver particles in the solvent is 50% by mass, a value of SPAN as measured by a photocentrifuge method under the following conditions is 3.3 or less:

SPAN: (V90−V10)/V50 Equation (1)
wherein when a sedimentation velocity is expressed by a cumulative distribution,
V10 is the sedimentation velocity at a cumulative value of 10%;
V90 is the sedimentation velocity at a cumulative value of 90%; and
V50 (median sedimentation velocity) is the sedimentation velocity at a cumulative value of 50%;
(Measurement Conditions for SPAN)
a measurement sample in which the concentration of the silver particles in the solvent is 50% by mass is prepared; a solvent having an octanol/water partition coefficient (Log Pow) of −2 or more and 4 or less is used as the solvent of the measurement sample; a glass cell (a glass cell with an optical path length of 2 mm) is charged with 0.2 ml of the measurement sample; under a temperature condition of 25 °C, the glass cell is rotated at a low speed at a centrifugal acceleration of 130 G. and data for 500 points are obtained at an interval of 5 seconds, and then the glass cell is rotated at a high speed at a centrifugal acceleration of 1160 G, and data for 500 points are obtained at an interval of 5 seconds; three points between a gas-liquid interface (the liquid surface of the measurement sample) and a solid-liquid interface (the interface between sedimented silver particles and the solvent) of the measurement sample are arbitrarily selected, and each of the three points is analyzed at a node width of 1 mm; each of the sedimentation velocities V90, V10, and V50 is determined from a moving distance of the particles and a time required for the movement, and the SPAN is calculated based on Equation (1).

Item 4. The silver particle dispersion according to item 3, wherein the silver particles have an average particle diameter of 50 to 600 nm.

Item 5. A conductive adhesive comprising the silver particles according to item 1 or 2.

Item 6. A conductive adhesive comprising the silver particles according to item 1 or 2 and a resin.

Item 7. A sintered body of the conductive adhesive according to item 5 or 6.

Item 8. An electronic part in which members are bonded with the sintered body according to item 7.

### Advantageous Effects of Invention

According to the present invention, it is possible to provide a conductive adhesive comprising silver particles dispersed in a solvent, the silver particles having good flowability, and excellent shape stability after being applied to a member and before being sintered. Furthermore, according to the present invention, it is also possible to provide a conductive adhesive comprising the silver particles, a sintered body of the conductive adhesive, and an electronic part comprising the sintered body between members.

### DESCRIPTION OF EMBODIMENTS

Silver particles of the present invention are silver particles dispersed in a solvent. In the silver particles of the present invention, an amine compound is adhered to a surface of the silver particles, and when a concentration of the silver particles in the solvent is 50% by mass, a value of SPAN as measured by a photocentrifuge method under the following conditions is 0.1 or more and 3.3 or less. Because of the above-described features, the silver particles of the present invention exhibit the property of having good flowability, and excellent shape stability after being applied to a member and before being sintered. The silver particles of the present invention, a conductive adhesive, a sintered body of the conductive adhesive, and an electronic part comprising the sintered body between members will be hereinafter described in detail.

SPAN: (V90−V10)/V50 Equation (1)
wherein when a sedimentation velocity is expressed by a cumulative distribution,
V10 is the sedimentation velocity at a cumulative value of 10%;
V90 is the sedimentation velocity at a cumulative value of 90%; and
V50 (median sedimentation velocity) is the sedimentation velocity at a cumulative value of 50%.
(Measurement Conditions for SPAN)

A measurement sample in which the concentration of the silver particles in the solvent is 50% by mass is prepared. A solvent having an octanol/water partition coefficient (Log Pow) of −2 or more and 4 or less is used as the solvent of the measurement sample. A glass cell (a glass cell with an optical path length of 2 mm) is charged with 0.2 ml of the measurement sample. Under a temperature condition of 25 °C, the glass cell is rotated at a low speed at a centrifugal acceleration of 130 G, and data for 500 points are obtained at an interval of 5 seconds, and then the glass cell is rotated at a high speed at a centrifugal acceleration of 1160 G, and data for 500 points are obtained at an interval of 5 seconds. Three points between a gas-liquid interface (the liquid surface of the measurement sample) and a solid-liquid interface (the interface between sedimented silver particles and the solvent) of the measurement sample are arbitrarily selected, and each of the three points is analyzed at a node width of 1 mm. Each of the sedimentation velocities V90, V10, and V50 is determined from a moving distance of the particles and a time required for the movement, and the SPAN is calculated based on Equation (1).

As used herein, values connected with “to” refer to a numerical range including the values before and after “to” as the lower and upper limits. When a plurality of lower limits and a plurality of upper limits are mentioned separately, any lower limit and any upper limit may be selected and connected with “to”.

### 1. Silver Particles

The silver particles of the present invention are particles containing silver. An amine compound is adhered to a surface of the silver particles. That is, the silver particles of the present invention have a structure in which an amine compound is adhered to the surface of each of the particles composed of silver.

In the silver particles of the present invention, the value of SPAN: (V90−V10)/V50, as measured by the photocentrifuge method under the above-described conditions, is 0.1 or more and 3.3 or less. The value of SPAN: (V90−V10)/V50 as measured by the photocentrifuge method is correlated with the particle size distribution of secondary particles of the silver particles; it can be said that the smaller the value of SPAN: (V90−V10)/V50, the narrower the particle size distribution of the secondary particles of the silver particles. In the present invention, when the value of SPAN: (V90−V10)/V50 of the silver particles to which an amine compound is adhered is within the specific range of 0.1 to 3.3, it can be assessed that the particle size distribution of the silver particles as secondary particles is within an appropriate range, such that further aggregation of the secondary particles is inhibited, and the silver particles are appropriately dispersed in the solvent. Attempts have previously been made to adjust the properties of conductive adhesives containing silver particles by controlling the primary particles of the silver particles. However, the present invention focuses on the dispersibility of the secondary particles of the silver particles, and controls the value of SPAN: (V90−V10)/V50 as measured by the photocentrifuge method within the specific range, thereby imparting, to the silver particles dispersed in the solvent, both good flowability, and excellent shape stability after being applied to a member and before being sintered. Specific measurement conditions for the photocentrifuge method are described in the Examples.

From the viewpoint of satisfactorily achieving the effect of the present invention, the value of SPAN: (V90−V10)/V50 of the silver particles of the present invention is preferably 0.1 or more, more preferably 0.3 or more, still more preferably 0.5 or more, and particularly preferably 0.7 or more. On the other hand, the value of SPAN is preferably 3.3 or less, more preferably 3.0 or less, still more preferably 2.5 or less, and particularly preferably 2.2 or less. Preferred ranges include from 0.1 to 3.3, from 0.3 to 3.0, from 0.5 to 2.5, and from 0.7 to 2.2.

In the present invention, the method of setting the value of SPAN: (V90−V10)/V50 of the silver particles within the specific range of 0.1 to 3.3 is not specifically limited; however, the value of SPAN can be adjusted as described below, for example, with the purification solvent (washing solvent) used to produce the silver particles, the washing method using the solvent, the solvent used for amine (protective group) replacement, the selection of the dispersion solvent or the method of dispersing the silver particles in the dispersion solvent, and the centrifugation conditions during production of the silver particles where concentration is required. In particular, the purification solvent needs to be selected according to the particle diameter and the protective group. If an appropriate purification solvent is not used, the particle size distribution of the secondary particles may be broadened when prepared as a high-concentration dispersion, or extremely large secondary particles may be produced. Furthermore, centrifugation conditions involving the application of an excessively high load G similarly affect the secondary particles. In addition, excessively low centrifugation conditions tend to broaden the distribution of the secondary particles. It is thus necessary to appropriately determine the centrifugation conditions according to the particle diameter and the type of solvent used during centrifugation.

From the viewpoint of satisfactorily achieving the effect of the present invention, the silver particles have an average particle diameter (primary particle diameter) of, for example, 600 nm or less, preferably 580 nm or less, more preferably 560 nm or less, still more preferably 550 nm or less, while having an average particle diameter (primary particle diameter) of preferably 50 nm or more, more preferably 60 nm or more, still more preferably 65 nm or more. Preferred ranges include from 50 to 600 nm, from 60 to 580 nm, and from 65 to 550 nm.

As used herein, the average particle diameter (primary particle diameter) of the silver particles refers to the volume-based average particle diameter measured for 200 randomly selected particles in a SEM image, using image analysis software (for example, Macview (Mountech)). The SED mode (secondary electron detector) is used in the observation, and a range with a lateral width of 1 to 20 μm is observed at an acceleration voltage of 20 kV and a magnification of 5,000 to 30,000 times. With respect to the vertical direction of the SEM image, the width is set such that 200 or more (typically about 200 to 300) silver particles are included in the range with a lateral width of 1 to 20 μm. The volume-based average particle diameter refers to the value measured based on the assumption that the particles observed in the SEM image have a spherical shape with that diameter. The specific measurement method is as described in the Examples.

From the viewpoint of satisfactorily achieving the effect of present invention, in the silver particles of the present invention, preferably, at least one exothermic peak is observed in the range of 120 to 250 °C, more preferably, at least one exothermic peak is observed in the range of 120 to 150 °C, and still more preferably, at least one exothermic peak is observed in the range of 160 to 250 °C, in thermogravimetry-differential thermal analysis. Typically, one such an exothermic peak is observed in these ranges.

A dry powder of the silver particles of the present invention preferably exhibits a weight loss of 1.5% by weight or less, and more preferably exhibits a weight loss of 0.05 to 1.3% by weight, upon heating from 30 to 500 °C by thermogravimetry-differential thermal analysis. The method of thermogravimetry-differential thermal analysis is as follows.

### <Thermogravimetry-Differential Thermal Analysis (TG-DTA)>

Initially, air-dried silver particles are prepared. For example, when silver particles in the solvent are obtained for analysis, 1 g of the silver particles dispersed in the solvent are dispersed well in 2 g of added methanol, and then the silver particles are collected by filtration and air-dried to obtain a silver-particle dry powder to be analyzed. The silver-particle dry powder is subjected to TG-DTA measurement, using a thermogravimetry-differential thermal analyzer (for example, HITACHI G300 AST-2). The measurement conditions are as follows: atmosphere: air, measurement temperature: 30 to 500 °C, heating rate: 10 °C/min. From the obtained TG-DTA chart, the exothermic peak due to binding of the silver particles in the TG-DTA analysis and the weight loss on heating from 30 to 500 °C by the thermal analysis are obtained.

The silver content in the silver particles of the present invention is preferably 95% by mass or more, and more preferably 98% by mass or more.

An amine compound is adhered to the surface of the silver particles of the present invention. That is, the silver particles of the present invention have been surface-treated with a treatment liquid containing an amine compound (surface-treated silver particles). The amine compound is adhered to the surface of the silver particles to form a protective layer.

The amine compound is not specifically limited as long as it can be adhered to the surface of the silver particles and allows the value of SPAN: (V90−V10)/V50 to be set within the specific range mentioned above, but is preferably an alkylamine, from the viewpoint of even more satisfactorily exhibiting the effect of the present invention. While the alkylamine is not specifically limited, it is preferably an alkylamine in which the alkyl group contains 3 or more and 18 or less carbon atoms, and is more preferably an alkylamine in which the alkyl group contains 4 or more and 12 or less carbon atoms.

Specific preferred examples of the alkylamine include ethylamine, n-propylamine, isopropylamine, 1,2-dimethylpropylamine, n-butylamine, isobutylamine, sec-butylamine, tert-butylamine, isoamylamine, tert-amylamine, 3-pentylamine, n-amylamine, n-hexylamine, n-heptylamine, n-octylamine, 2-octylamine, 2-ethylhexylamine, n-nonylamine, n-aminodecane, n-aminoundecane, n-dodecylamine, n-tridecylamine, 2-tridecylamine, n-tetradecylamine, n-pentadecylamine, n-hexadecylamine, n-heptadecylamine, n-octadecylamine, n-oleylamine, N-ethyl-1,3-diaminopropane, N,N-diisopropylethylamine, N,N-dimethylaminopropane, N,N-dibutylaminopropane, N,N-dimethyl-1,3-diaminopropane, N,N-diethyl-1,3-diaminopropane, N,N-diisobutyl-1,3-diaminopropane, and N-lauryl diaminopropane. Examples also include dibutyl amine, which is a secondary amine, and cyclopropylamine, cyclobutylamine, cyclopropylamine, cyclohexylamine, cycloheptylamine, and cyclooctylamine, which are cyclic alkylamines, and 2-(2-aminoethylamino) ethanol. From the viewpoint of even more satisfactorily achieving the effect of the present invention, preferred among these are n-propylamine, isopropylamine, cyclopropylamine, n-butylamine, isobutylamine, sec-butylamine, tert-butylamine, cyclobutylamine, n-amylamine, n-hexylamine, cyclohexylamine, n-octylamine, 2-ethylhexylamine, n-dodecylamine, n-oleylamine, N,N-dimethyl-1,3-diaminopropane, and N,N-diethyl-1,3-diaminopropane; more preferred are n-butylamine, n-hexylamine, cyclohexylamine, n-octylamine, n-dodecylamine, N,N-dimethyl-1,3-diaminopropane, and N,N-diethyl-1,3-diaminopropane; and particularly preferred is n-hexylamine. These amine compounds may be used alone or in combination.

While the amount of the amine compound to be adhered to the silver particles of the present invention is not specifically limited, it is preferably 1.5% by mass or less, and more preferably 1.3% by mass or less, based on the mass of the silver particles taken as 100% by mass. The lower limit is preferably 0.05% by mass or more. The content of the amine compound adhered to the silver particles can be measured by thermogravimetry-differential thermal analysis.

A fatty acid, a hydroxyfatty acid, and the like may also be adhered to the surface of the silver particles. While the fatty acid is not specifically limited, it is preferably a fatty acid in which the alkyl group contains 3 or more and 18 or less carbon atoms, and is more preferably a fatty acid in which the alkyl group contains 4 or more and 18 or less carbon atoms. Specific preferred examples of the fatty acid include acetic acid, propionic acid, butyric acid, valeric acid, caproic acid, caprylic acid, 2-ethylhexanoic acid, capric acid, lauric acid, myristic acid, palmitic acid, stearic acid, oleic acid, linoleic acid, and α-linolenic acid. Specific examples of the fatty acid also include cyclic alkylcarboxylic acids, such as cyclohexanecarboxylic acid. The hydroxyfatty acid may be a compound having 3 to 24 carbon atoms and having one or more (for example, one) hydroxyl group(s). Examples of the hydroxyfatty acid include 2-hydroxydecanoic acid, 2-hydroxydodecanoic acid, 2-hydroxytetradecanoic acid, 2-hydroxyhexadecanoic acid, 2-hydroxyoctadecanoic acid, 2-hydroxyeicosanoic acid, 2-hydroxydocosanoic acid, 2-hydroxytricosanoic acid, 2-hydroxytetracosanoic acid, 3-hydroxyhexanoic acid, 3-hydroxyoctanoic acid, 3-hydroxynonanoic acid, 3-hydroxydecanoic acid, 3-hydroxyundecanoic acid, 3-hydroxydodecanoic acid, 3-hydroxytridecanoic acid, 3-hydroxytetradecanoic acid, 3-hydroxyhexadecanoic acid, 3-hydroxyheptadecanoic acid, 3-hydroxyoctadecanoic acid, o-hydroxy-2-decenoic acid, o-hydroxypentadecanoic acid, w-hydroxyheptadecanoic acid, @-hydroxyeicosanoic acid, @-hydroxydocosanoic acid, 6-hydroxyoctadecanoic acid, ricinoleic acid, 12-hydroxystearic acid, and [R-(E)]-12-hydroxy-9-octadecenoic acid. Preferred among the above are hydroxyfatty acids containing 4 to 18 carbon atoms and having one hydroxyl group at a position other than the @-position (particularly the 12-position), and more preferred are ricinoleic acid and 12-hydroxystearic acid. These fatty acids may be used alone or in combination. Likewise, these hydroxyfatty acids may be used alone or in combination.

In the silver particles of the present invention, the amount of the fatty acid or the hydroxyfatty acid to be adhered is also adjusted appropriately, as with the amine compound. While the amount of the fatty acid or the hydroxyfatty acid to be adhered is not specifically limited, it is preferably 1.5% by mass or less, and more preferably 1.3% by mass or less, based on the mass of the silver particles taken as 100% by mass. The lower limit is preferably 0.01% by mass or more. The content of the fatty acid or the hydroxyfatty acid adhered to the silver particles can be measured by thermogravimetry-differential thermal analysis.

As long as the amine compound is adhered to the surface of the silver particles of the present invention and the silver particles satisfy the value of SPAN: (V90−V10)/V50 mentioned above, the amine compound, the fatty acid, and the hydroxyfatty acid may be used in combination, or another compound different from these compounds may be adhered to the surface of the silver particles.

The silver particles of the present invention are dispersed in a solvent. That is, the silver particles are present in a dispersed state in the solvent. The solvent is not specifically limited as long as it has an octanol/water partition coefficient (Log Pow) of −2 or more and 4 or less.

From the viewpoint of satisfactorily achieving the effect of the present invention, preferred examples of the solvent include diethylene glycol monohexyl ether (Log Pow: 1.7), Texanol (Log Pow: 3.2), isopropyl alcohol (Log Pow: 0.05), α-terpineol (Log Pow: 2.98), diethylene glycol (Log Pow: −1.98), ethylene glycol (Log Pow: −1.36), 2-ethyl-1,3-hexanediol (Log Pow: 1.60), diethylene glycol mono-2-ethylhexyl ether (Log Pow: 2.23), butyl carbitol (Log Pow: 0.56), butyl carbitol acetate (Log Pow: 2.9), and butanediol (Log Pow: −0.34). The solvent may be only a single solvent or two or more solvents, preferably a single solvent.

From the viewpoint of more satisfactorily achieving the effect of the present invention, the concentration of the silver particles of the present invention in the solvent is preferably 80% by mass or more, more preferably 85% by mass or more, and still more preferably 88% by mass or more, while the concentration is preferably 95% by mass or less, more preferably 93% by mass or less, and still more preferably 92% by mass or less. Preferred ranges include from 80 to 95% by mass, from 85 to 93% by mass, and from 88 to 92% by mass. For measuring the value of SPAN: (V90−V10)/V50 for the silver particles of the present invention, the concentration is adjusted to 50% by mass.

### 2. Method for Producing the Silver Particles

One exemplary method for producing the silver particles of the present invention will be hereinafter described.

Initially, a composition for producing the silver particles (silver particle-preparation composition) is prepared. Specifically, a silver compound as a raw material of the silver particles, an amine compound to be adhered to the surface of the silver particles, and a solvent to be used in each step (such as a solvent to be used for synthesis of the silver particles, a purification solvent for the silver particles, and a solvent for replacing the amine compound) are prepared.

The silver particles are synthesized through the step of synthesizing silver particles from the silver compound, the step of replacing the amine, and the like, and separation of the silver particles may be included during each step or between the steps.

From the viewpoint of even more satisfactorily achieving the effect of the present invention, the silver compound is preferably silver nitrate, silver oxalate, or the like, and is particularly preferably silver oxalate.

The solvent to be used for synthesizing the silver particles from the silver compound is not specifically limited as long as it allows synthesis of the silver particles, but the solvent preferably contains a polar organic solvent. Examples of the polar organic solvent include ketones, such as acetone, acetylacetone, and methyl ethyl ketone; ethers, such as diethyl ether, dipropyl ether, dibutyl ether, tetrahydrofuran, and 1,4-dioxane; diols, such as 1,2-propanediol, 1,2-butanediol, 1,3-butanediol, 1,4-butanediol, 2,3-butanediol, 1,2-hexanediol, 1,6-hexanediol, 1,2-pentanediol, 1,5-pentanediol, 2-methyl-2,4-pentanediol, 3-methyl-1,5-pentanediol, 1,2-octanediol, 1,8-octanediol, and 2-ethyl-1,3-hexanediol; glycerol; alcohols, such as linear or branched alcohols containing 1 to 5 carbon atoms, cyclohexanol, 3-methoxy-3-methyl-1-butanol, and 3-methoxy-1-butanol; fatty acid esters, such as ethyl acetate, butyl acetate, ethyl butylate, ethyl formate, and Texanol; glycols or glycol ethers, such as polyethylene glycol, triethylene glycol monomethyl ether, tetraethylene glycol monomethyl ether, ethylene glycol monoethyl ether, diethylene glycol monoethyl ether, diethylene glycol dimethyl ether, triethylene glycol dimethyl ether, tetraethylene glycol dimethyl ether, 3-methoxybutyl acetate, ethylene glycol monobutyl ether, ethylene glycol monobutyl ether acetate, ethylene glycol monohexyl ether, ethylene glycol monooctyl ether, ethylene glycol mono-2-ethylhexyl ether, ethylene glycol monobenzyl ether, diethylene glycol monomethyl ether, diethylene glycol monomethyl ether acetate, diethylene glycol monoethyl ether, diethylene glycol monoethyl ether acetate, diethylene glycol monobutyl ether, diethylene glycol monobutyl ether acetate, diethylene glycol monohexyl ether, diethylene glycol mono-2-ethylhexyl ether, polypropylene glycol, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, tripropylene glycol monoethyl ether, tripropylene glycol monopropyl ether, and tripropylene glycol monobutyl ether; N,N-dimethylformamide; dimethylsulfoxide; terpenes, such as terpineol; acetonitrile; γ-butyrolactone; 2-pyrrolidone; N-methylpyrrolidone; and N-(2-aminoethyl) piperazine. From the viewpoint of even more satisfactorily achieving the effect of the present invention, preferred among the above are linear or branched alcohols containing 3 to 5 carbon atoms, 3-methoxy-3-methyl-1-butanol, 3-methoxy-1-butanol, diethylene glycol monobutyl ether, diethylene glycol monobutyl ether acetate, diethylene glycol monohexyl ether, diethylene glycol mono-2-ethylhexyl ether, terpineol, and Texanol.

The solvent may also contain a nonpolar or hydrophobic solvent, in addition to the polar organic solvent. Examples of the nonpolar organic solvent include linear, branched, or cyclic saturated hydrocarbons, such as hexane, heptane, octane, nonane, decane, 2-ethylhexane, and cyclohexane; alcohols, such as linear or branched alcohols containing 6 or more carbon atoms; aromatic compounds, such as benzene, toluene, and benzonitrile; halogenated hydrocarbons, such as dichloromethane, chloroform, and dichloroethane; methyl-n-amyl ketone; methyl ethyl ketone oxime; and triacetin. Preferred among the above are saturated hydrocarbons and linear or branched alcohols containing 6 or more carbon atoms, and more preferred are hexane, octane, decane, octanol, decanol, and dodecanol. These solvents may be used alone or as a mixture of two or more.

In the step of synthesizing the silver particles from the silver compound, the silver compound, the amine compound, and the solvent are mixed to obtain a silver particle-preparation composition. The proportions of these components in the composition are appropriately adjusted. For example, the content of silver oxalate in the composition is preferably about 20 to 70% by mass, based on the total amount of the composition. The content of the amine compound is preferably about 5 to 55% by mass, based on the total amount of the composition. When the fatty acid is to be adhered to the surface of the silver particles, the content of the fatty acid is preferably about 0.1 to 20% by mass, based on the total amount of the composition. When the hydroxyfatty acid is to be adhered to the surface of the silver particles, the content of the hydroxyfatty acid is preferably about 0.1 to 15% by mass, based on the total amount of the composition.

After the synthesis of silver particles to which the amine compound is adhered, the types of the amine compound and the like and the amounts of the amine compound and the like to be adhered can be adjusted (the amine compound can be replaced), using the below-described method. Therefore, the amine compound used in the step of synthesizing the silver particles from the silver compound may be different from the amine compound adhered to the surface of the silver particles as a final product.

The means of mixing the components is not specifically limited, and the mixing may be performed using a general-purpose device, such as a mechanical stirrer, a magnetic stirrer, a vortex mixer, a planetary mill, a ball mill, a three-roll, a line mixer, a planetary mixer, or a dissolver. In order to avoid an increase in the temperature of the composition due to the influence of the heat of dissolution, frictional heat, and the like during mixing, which may initiate the pyrolysis reaction of the silver particles, it is preferred to perform the mixing while keeping the temperature of the composition at, for example, 60 °C or less, particularly 40 °C or less.

Next, the silver particle-preparation composition is reacted, typically by heating, in a reaction vessel, to cause the pyrolysis reaction of the silver compound, resulting in the formation of silver particles. The reaction may be performed by introducing the composition into a pre-heated reaction vessel, or introducing the composition into a reaction vessel and then heating.

The reaction temperature may be any temperature that allows the pyrolysis reaction to proceed and allows the silver particles to form, for example, about 50 to 250 °C. The reaction time may be selected appropriately according to the desired size of the average particle diameter and the corresponding composition of the composition. The reaction time is, for example, from 1 minute to 100 hours.

The silver particles formed by the pyrolysis reaction are obtained as a mixture containing unreacted raw material, and thus, are preferably purified. Examples of purification methods include solid-liquid separation methods and a sedimentation method utilizing the difference in specific gravity between the silver particles and the unreacted raw material such as an organic solvent. Examples of solid-liquid separation methods include filtration, centrifugation, a cyclone method, and decantation. For ease of handling during purification, the viscosity of the mixture containing the silver particles may be adjusted by diluting it with a low-boiling-point solvent, such as acetone or methanol.

The average particle diameter (primary particle diameter) of the silver particles to be obtained can be adjusted by adjusting the composition and reaction conditions of the silver particle-production composition. In the present invention, from the viewpoint of setting the value of SPAN: (V90−V10)/V50 within the specific range mentioned above, a solvent such as n-propanol, 1-butanol, or the like is preferably used as the purification solvent. The selection of purification solvent affects the value of SPAN: (V90−V10)/V50 of the silver particles of the present invention.

### Method of Replacing and Adjusting the Amine Compound on the Surface of the Silver Particles

Silver particles (in which the amine compound is adhered to the surface) previously synthesized using the method described above are prepared and then dispersed in a solvent. Examples of the solvent include the same solvents as those mentioned as the solvent to be used in the step of synthesizing the silver particles, but preferably, n-propanol, isopropanol, 1-butanol, and the like are used. The selection of the solvent to be used for replacing and adjusting the amine compound on the surface of the silver particles affects the value of SPAN: (V90−V10)/V50 of the silver particles of the present invention. Next, another amine compound is added in an amount in the range of 0.1 to 5 times the mass of the silver particles, and the mixture is subjected to the step of stirring for 1 minute to 24 hours at room temperature to 80 °C. As a result, the type of the amine compound adhered to the surface of the silver particles can be replaced, or the amount of the amine compound adhered can be adjusted. The silver particles in which the amine compound has been replaced can be collected using the above-described solid-liquid separation methods, for example. The solvent to be used in the solid-liquid separation is preferably n-propanol, isopropanol, 1-butanol, or the like. The selection of this solvent also affects the value of SPAN: (V90−V10)/V50 of the silver particles of the present invention.

### 3. Conductive Adhesive

A conductive adhesive of the present invention comprises the silver particles of the present invention. That is, the conductive adhesive of the present invention comprises the silver particles and a solvent. Details of the silver particles of the present invention and the solvent are as described above.

The conductive adhesive of the present invention may further comprise a resin in addition to the silver particles of the present invention and the solvent. The resin is not specifically limited, and any resin used in known conductive adhesives containing silver particles, for example, thermoplastic resins and thermosetting resins, can be used in the present invention. Examples of thermoplastic resins include urethane resins, acrylic resins, methacrylic resins, polyvinyl alcohol resins, vinyl acetate resins, polycarbonate resins, polyorganosiloxane-based resins, and polyamide resins. These resins may be used as a mixture. Examples of thermosetting resins include epoxy resins, acrylic resins, silicone resins, urethane resins, vinyl ester resins, phenol resins, urea resins, melamine resins, unsaturated polyester resins, diallyl phthalate resins, and polyimide resins. In the present invention, specific examples of preferred solvents include diethylene glycol monohexyl ether (Log Pow: 1.7), Texanol (Log Pow: 3.2), isopropyl alcohol (Log Pow: 0.05), α-terpineol (Log Pow: 2.98), diethylene glycol (Log Pow: −1.98), ethylene glycol (Log Pow: −1.36), 2-ethyl-1,3-hexanediol (Log Pow: 1.60), diethylene glycol mono-2-ethylhexyl ether (Log Pow: 2.23), butyl carbitol (Log Pow: 0.56), butyl carbitol acetate (Log Pow: 2.9), and butanediol (Log Pow: −0.34). Particularly preferred solvents are diethylene glycol mono-2-ethylhexyl ether (Log Pow: 2.23) and Texanol (Log Pow: 3.2). When the conductive adhesive of the present invention further contains a solvent, the solvent contained in the conductive adhesive may be a single solvent or two or more solvents.

The content of the silver particles in the conductive adhesive of the present invention is preferably 80% by mass or more, more preferably 85% by mass or more, and still more preferably 88% by mass or more, while the content is preferably 95% by mass or less, more preferably 93% by mass or less, and still more preferably 92% by mass or less. Preferred ranges include from 80 to 95% by mass, from 85 to 93% by mass, and from 88 to 92% by mass. When the conductive adhesive of the present invention comprises a resin, the content of the resin in the conductive adhesive of the present invention is preferably 0.001% by mass or more, more preferably 0.005% by mass or more, and still more preferably 0.01% by mass or more, while the content is preferably 10% by mass or less, more preferably 7% by mass or less, and still more preferably 3% by mass or less. Preferred ranges include from 0.001 to 10% by mass, from 0.005 to 7% by mass, and from 0.01 to 3% by mass.

### 4. Sintered Body of the Conductive Adhesive

A sintered body of the conductive adhesive of the present invention is obtained by sintering the conductive adhesive of the present invention described in detail in the “3. Conductive Adhesive” section above. In the sintered body of the conductive adhesive of the present invention, the components (amine compound and the like) adhered to the surface of the silver particles, the solvent, and the resin have been mostly eliminated by the high heat applied during sintering, and the sintered body is substantially composed of silver.

While the sintering temperature is not specifically limited, it is, for example, 250 °C or less, preferably about 150 to 250 °C, and more preferably about 200 to 250 °C. The sintering time is preferably about 0.4 to 2.0 hours, and more preferably about 0.5 to 1.2 hours. Pressure may or may not be applied during sintering of the conductive adhesive of the present invention. The applied pressure is, for example, about 10 to 30 MPa. The sintering may be performed in an atmosphere such as air or an inert gas (nitrogen gas or argon gas). The sintering means is not specifically limited, and examples include an oven, a hot air-type drying oven, an infrared drying oven, laser irradiation, flash lamp irradiation, and microwaves.

### 5. Electronic Part

An electronic part of the present invention comprises a region between members that is bonded with the sintered body of the present invention. That is, the electronic part of the present invention is obtained by placing the conductive adhesive of the present invention described in detail in the “3. Conductive Adhesive” section above between members of the electronic part (for example, between members included in a circuit), and sintering the conductive adhesive to bond the members.

### EXAMPLES

The present invention will be described in more detail with the following examples; however, the present invention is not limited thereto.

Details of the components used in the examples and comparative examples are as follows:
Silver oxalate ((COOAg) 2) was synthesized using the method disclosed in Japanese Patent No. 5574761.
N,N-Diethyl-1,3-diaminopropane (from FUJIFILM Wako Pure Chemical Corporation)
n-Hexylamine (containing 6 carbon atoms, from FUJIFILM Wako Pure Chemical Corporation)
2-(2-Aminoethylamino) ethanol (from Tokyo Chemical Industry Co., Ltd)
Ricinoleic acid (from Tokyo Chemical Industry Co., Ltd) #n-Propanol (from FUJIFILM Wako Pure Chemical Corporation)
Isopropyl alcohol (from FUJIFILM Wako Pure Chemical Corporation)
1-Butanol (from FUJIFILM Wako Pure Chemical Corporation)
Methanol (from FUJIFILM Wako Pure Chemical Corporation)
Diethylene glycol mono-2-ethylhexyl ether (from FUJIFILM Wako Pure Chemical Corporation)

The silver particles were produced by the following procedure. When several samples were required for evaluation, the required number of samples was prepared by increasing the number of attempts following the same method.

### Example 1: Synthesis of Silver Particles 1

Silver particles 1 dispersed in a solvent were produced by the following procedure. 50-mL glass centrifuge tubes containing a magnetic stirring bar were charged with ricinoleic acid (0.05 g), N,N-diethyl-1,3-diaminopropane (4.1 g), and 1-butanol (7.5 g), followed by stirring for about 1 minute, and then charged with silver oxalate (5 g), followed by stirring for about 10 minutes, to obtain a silver particle 1-preparation composition. Thereafter, these glass centrifuge tubes were set upright on a hot stirrer equipped with an aluminum block (HHE-19G-U from Koike Precision Instruments), stirred at 40 °C for 30 minutes, and additionally stirred at 90 °C for 30 minutes. After allowing to cool, the magnetic stirring bar was removed, 15 g of n-propanol was added to each composition and stirred with a vortex mixer, the composition was then subjected to centrifugal sedimentation in a centrifuge (CF7D2 from Hitachi Koki Co., Ltd.) at 2500 rpm (centrifugal acceleration of about 1110×G) for 1 minute, and the supernatant was removed by tilting the centrifuge tubes. The process of adding 15 g of n-propanol, stirring, centrifugation, and removing the supernatant was repeated twice to collect silver particles. Next, to the dispersion (n-propanol solution) of the silver particles obtained above, n-hexylamine was added in an amount three times the mass of the silver particles, and the mixture was stirred at room temperature for 4 hours. After stirring, the magnetic stirring bar was removed, 15 g of n-propanol was added to each composition and stirred with a vortex mixer, the composition was then subjected to centrifugal sedimentation in a centrifuge (CF7D2 from Hitachi Koki Co., Ltd.) at 2500 rpm (centrifugal acceleration of about 1110×G) for 1 minute, and the supernatant was removed by tilting the centrifuge tubes. Next, the process of adding 15 g of diethylene glycol mono-2-ethylhexyl ether, stirring, centrifugation, and removing the supernatant was repeated twice to collect silver particles 1.

### Example 2: Synthesis of Silver Particles 2

Silver particles 2 dispersed in a solvent were produced by the following procedure. 50-mL glass centrifuge tubes containing a magnetic stirring bar were charged with ricinoleic acid (0.05 g), N,N-diethyl-1,3-diaminopropane (4.1 g), and 1-butanol (7.5 g), followed by stirring for about 1 minute, and then charged with silver oxalate (5 g), followed by stirring for about 10 minutes, to obtain a silver particle 2-preparation composition. Thereafter, these glass centrifuge tubes were set upright on a hot stirrer equipped with an aluminum block (HHE-19G-U from Koike Precision Instruments), stirred at 40 °C for 30 minutes, and additionally stirred at 90 °C for 30 minutes. After allowing to cool, the magnetic stirring bar was removed, 15 g of isopropyl alcohol was added to each composition and stirred with a vortex mixer, the composition was then subjected to centrifugal sedimentation in a centrifuge (CF7D2 from Hitachi Koki Co., Ltd.) at 2500 rpm (centrifugal acceleration of about 1110×G) for 1 minute, and the supernatant was removed by tilting the centrifuge tubes. The process of adding 15 g of isopropyl alcohol, stirring, centrifugation, and removing the supernatant was repeated twice to collect silver particles. Next, to the dispersion (isopropyl alcohol solution) of the silver particles obtained above, n-hexylamine was added in an amount three times the mass of the silver particles, and the mixture was stirred at room temperature for 4 hours. After stirring, the magnetic stirring bar was removed, 15 g of isopropyl alcohol was added to each composition and stirred with a vortex mixer, the composition was then subjected to centrifugal sedimentation in a centrifuge (CF7D2 from Hitachi Koki Co., Ltd.) at 2500 rpm (centrifugal acceleration of about 1110×G) for 1 minute, and the supernatant was removed by tilting the centrifuge tubes. Next, the process of adding 15 g of diethylene glycol mono-2-ethylhexyl ether, stirring, centrifugation, and removing the supernatant was repeated twice to collect silver particles 2.

### Example 3: Synthesis of Silver Particles 3

Silver particles 3 dispersed in a solvent were produced by the following procedure. 50-mL glass centrifuge tubes containing a magnetic stirring bar were charged with ricinoleic acid (0.05 g), N,N-diethyl-1,3-diaminopropane (4.1 g), and 1-butanol (7.5 g), followed by stirring for about 1 minute, and then charged with silver oxalate (5 g), followed by stirring for about 10 minutes, to obtain a silver particle 3-preparation composition. Thereafter, these glass centrifuge tubes were set upright on a hot stirrer equipped with an aluminum block (HHE-19G-U from Koike Precision Instruments), stirred at 40 °C for 30 minutes, and additionally stirred at 90 °C for 30 minutes. After allowing to cool, the magnetic stirring bar was removed, 15 g of 1-butanol was added to each composition and stirred with a vortex mixer, the composition was then subjected to centrifugal sedimentation in a centrifuge (CF7D2 from Hitachi Koki Co., Ltd.) at 2500 rpm (centrifugal acceleration of about 1110×G) for 1 minute, and the supernatant was removed by tilting the centrifuge tubes. The process of adding 15 g of 1-butanol, stirring, centrifugation, and removing the supernatant was repeated twice to collect silver particles. Next, to the dispersion (1-butanol solution) of the silver particles thus obtained, n-hexylamine was added in an amount three times the mass of the silver particles, and stirred at room temperature for 4 hours. After stirring, the magnetic stirring bar was removed, 15 g of 1-butanol was added to each composition and stirred with a vortex mixer, the composition was then subjected to centrifugal sedimentation in a centrifuge (CF7D2 from Hitachi Koki Co., Ltd.) at 2500 rpm (centrifugal acceleration of about 1110×G) for 1 minute, and the supernatant was removed by tilting the centrifuge tubes. Next, the process of adding 15 g of diethylene glycol mono-2-ethylhexyl ether, stirring, centrifugation, and removing the supernatant was repeated twice to collect silver particles 3.

### Example 4: Synthesis of Silver Particles 4

Silver particles 4 dispersed in a solvent were produced by the following procedure. 50-mL glass centrifuge tubes containing a magnetic stirring bar were charged with 2-(2-aminoethylamino) ethanol (1.74 g) and 1-butanol (7.5 g), followed by stirring for about 1 minute, and then charged with silver oxalate (5 g), followed by stirring for about 10 minutes, to obtain a silver particle 4-preparation composition. Thereafter, these glass centrifuge tubes were set upright on a hot stirrer equipped with an aluminum block (HHE-19G-U from Koike Precision Instruments), stirred at 40 °C for 30 minutes, and additionally stirred at 90 °C for 30 minutes. After allowing to cool, the magnetic stirring bar was removed, 15 g of methanol was added to each composition and stirred with a vortex mixer, the composition was then subjected to centrifugal sedimentation in a centrifuge (CF7D2 from Hitachi Koki Co., Ltd.) at 2500 rpm (centrifugal acceleration of about 1110×G) for 1 minute, and the supernatant was removed by tilting the centrifuge tubes. The process of adding 15 g of methanol, stirring, centrifugation, and removing the supernatant was repeated twice to collect silver particles. Next, to the dispersion (methanol solution) of the silver particles obtained above, n-hexylamine was added in an amount three times the mass of the silver particles, and the mixture was stirred at room temperature for 4 hours. After stirring, the magnetic stirring bar was removed, 15 g of methanol was added to each composition and stirred with a vortex mixer, the composition was then subjected to centrifugal sedimentation in a centrifuge (CF7D2 from Hitachi Koki Co., Ltd.) at 2500 rpm (centrifugal acceleration of about 1110×G) for 1 minute, and the supernatant was removed by tilting the centrifuge tubes. Next, the process of adding 15 g of diethylene glycol mono-2-ethylhexyl ether, stirring, centrifugation, and removing the supernatant was repeated twice to collect silver particles 4.

### Example 5: Synthesis of Silver Particles 5

Silver particles 5 dispersed in a solvent were produced by the following procedure. 50-mL glass centrifuge tubes containing a magnetic stirring bar were charged with 2-(2-aminoethylamino) ethanol (1.74 g) and 1-butanol (7.5 g), followed by stirring for about 1 minute, and then charged with silver oxalate (5 g), followed by stirring for about 10 minutes, to obtain a silver particle 5-preparation composition. Thereafter, these glass centrifuge tubes were set upright on a hot stirrer equipped with an aluminum block (HHE-19G-U from Koike Precision Instruments), stirred at 40 °C for 30 minutes, and additionally stirred at 90 °C for 30 minutes. After allowing to cool, the magnetic stirring bar was removed, 15 g of n-propanol was added to each composition and stirred with a vortex mixer, the composition was then subjected to centrifugal sedimentation in a centrifuge (CF7D2 from Hitachi Koki Co., Ltd.) at 2500 rpm (about 1110×G) for 1 minute, and the supernatant was removed by tilting the centrifuge tubes. The process of adding 15 g of n-propanol, stirring, centrifugation, and removing the supernatant was repeated twice to collect silver particles. Next, to the dispersion (methanol solution) of the silver particles obtained above, n-hexylamine was added in an amount three times the mass of the silver particles, and the mixture was stirred at room temperature for 4 hours. After stirring, the magnetic stirring bar was removed, 15 g of n-propanol was added to each composition and stirred with a vortex mixer, the composition was then subjected to centrifugal sedimentation in a centrifuge (CF7D2 from Hitachi Koki Co., Ltd.) at 2500 rpm (centrifugal acceleration of about 1110×G) for 1 minute, and the supernatant was removed by tilting the centrifuge tubes. Next, the process of adding 15 g of diethylene glycol mono-2-ethylhexyl ether, stirring, centrifugation, and removing the supernatant was repeated twice to collect silver particles 5.

### Comparative Example 1: Synthesis of Silver Particles 6

Silver particles 6 dispersed in a solvent were produced by the following procedure. 50-mL glass centrifuge tubes containing a magnetic stirring bar were charged with ricinoleic acid (0.05 g), N,N-diethyl-1,3-diaminopropane (4.1 g), and 1-butanol (7.5 g), followed by stirring for about 1 minute, and then charged with silver oxalate (5 g), followed by stirring for about 10 minutes, to obtain a silver particle 6-preparation composition. Thereafter, these glass centrifuge tubes were set upright on a hot stirrer equipped with an aluminum block (HHE-19G-U from Koike Precision Instruments), stirred at 40 °C for 30 minutes, and additionally stirred at 90 °C for 30 minutes. After allowing to cool, the magnetic stirring bar was removed, 15 g of methanol was added to each composition and stirred with a vortex mixer, the composition was then subjected to centrifugal sedimentation in a centrifuge (CF7D2 from Hitachi Koki Co., Ltd.) at 3000 rpm (centrifugal acceleration of about 1600×G) for 1 minute, and the supernatant was removed by tilting the centrifuge tubes. The process of adding 15 g of methanol, stirring, centrifugation, and removing the supernatant was repeated twice to collect silver particles. Next, to the dispersion (methanol solution) of the silver particles obtained above, n-hexylamine was added in an amount three times the mass of the silver particles, and the mixture was stirred at room temperature for 4 hours. After stirring, the magnetic stirring bar was removed, 15 g of methanol was added to the composition and stirred with a vortex mixer, the composition was then subjected to centrifugal sedimentation at 3000 rpm (centrifugal acceleration of about 1600×G) for 1 minute using a centrifuge (CF7D2 from Hitachi Koki Co., Ltd.), and the supernatant was removed by tilting the centrifuge tubes. Next, the process of adding 15 g of diethylene glycol mono-2-ethylhexyl ether, stirring, centrifugation, and removing the supernatant was repeated twice to collect silver particles 6.

For each of the silver particles 1 to 6, observation with a scanning electron microscope (acquisition of a SEM image), measurement of average particle diameter (volume-based average particle diameter), measurement of particle size distribution, and TG-DTA measurement were performed under the following conditions.

<Observation with Electron Microscope>

For each of the silver particles 1 to 6, a SEM image was acquired using a scanning electron microscope (SEM (JSM-IT500 HR from JEOL Ltd.)).

### <Measurement of Average Particle Diameter (Volume-Based Average Particle Diameter)>

For each of the SEM images (lateral width: 1 to 20 μm) acquired in <Observation with Electron Microscope> above, the volume-based average particle diameter (primary particle diameter) of 200 randomly selected particles was measured using image analysis software (Macview (Mountech)). With respect to the vertical direction of the SEM image, a range with a lateral width of 1 to 20 μm was observed. With respect to the vertical direction of the SEM image, the width was set such that 200 or more (typically about 200 to 300) silver particles were included in the range with a lateral width of 1 to 20 μm. The volume-based average particle diameter refers to the value measured based on the assumption that the particles observed in the SEM image have a spherical shape with that diameter. The results are shown in Table 1.

### <Photocentrifuge Method>

For each of the silver particles 1 to 6, the value of SPAN shown below was obtained by the photocentrifuge method.

SPAN: (V90−V10)/V50 Equation (1)
wherein when a sedimentation velocity is expressed by a cumulative distribution,
V10 is the sedimentation velocity at a cumulative value of 10%;
V90 is the sedimentation velocity at a cumulative value of 90%; and
V50 (median sedimentation velocity) is the sedimentation velocity at a cumulative value of 50%.
(Measurement Conditions for SPAN)

A measurement sample in which the concentration of the silver particles in the solvent was 50% by mass was prepared. A solvent having an octanol/water partition coefficient (Log Pow) of −2 or more and 4 or less was used as the solvent of the measurement sample. The silver particles (1 to 6) were each dispensed into a 50 ml vial, and diluted with diethylene glycol mono-2-ethylhexyl ether to give a silver concentration of 50% by mass and a solvent concentration of 50% by mass to make a total of 100%. A vortex mixer was used for kneading, and the mixture was dispersed at 2000 rpm for 2 minutes. It should be noted here that if the mixture does not visually appear to be dispersed (if solids remain), the mixture may be dispersed by rough kneading with a spatula or the like or by using a planetary centrifugal mixer or the like. When using a planetary centrifugal mixer, stirring should be performed so as to prevent sedimentation of the particles, by balancing the rotation and the revolution. In addition, when a silver particle dispersion in which the silver particles are dispersed is used for measurement and a measurement sample is prepared therefrom, the measurement sample should be prepared by diluting with the solvent in which the silver particles are dispersed, as a diluent. When a plurality of solvents are used in the dispersion, the plurality of solvents may be used, and the dilution should be made with the solvents at a ratio equivalent to that of the dispersion. The SPAN ((V90−V10)/V50) was measured using the model LS-610 dispersibility evaluation/particle size distribution analysis apparatus from LUM Japan. Specifically, a glass cell (a glass cell with an optical path length of 2 mm) was charged with 0.2 ml of the measurement sample. Under a temperature condition of 25 °C, the glass cell was rotated at a low speed at a centrifugal acceleration of 130 G, and data for 500 points were obtained at an interval of 5 seconds, and then the glass cell was rotated at a high speed at a centrifugal acceleration of 1160 G, and data for 500 points were obtained at an interval of 5 seconds Three points between a gas-liquid interface (the liquid surface of the measurement sample) and a solid-liquid interface (the interface between sedimented silver particles and the solvent) of the measurement sample were arbitrarily selected, and each of the three points was analyzed at a node width of 1 mm. Each of the sedimentation velocities V90, V10, and V50 was determined from the moving distance of the particles and the time, and the SPAN was calculated based on Equation (1). The LightFactor during measurement was set to 6. It should be noted that if a glass cell is not used during measurement, the silver particles may stick and light may be blocked, which hinders accurate measurement of the optical density (absorbance). In addition, if the LightFactor is not set to 6, the intensity of light is insufficient due to the nature of the high-concentration metal particle dispersion to be measured. Therefore, the LightFactor needs to be set to 6, in order to measure the state of secondary particles of the high-concentration particle dispersion. When the form of the secondary particles is measured by the same principle, consideration needs to be given to the light source of the measurement apparatus. In addition, if the nodes (analysis widths) overlap each other, an appropriate number of points cannot be obtained as the number of measured profiles (the number of measurement points). Therefore, the analysis needs to be performed so that the nodes do not overlap each other. The measurement results are shown in Table 1.

### <Flowability Evaluation>

The flowability of each of the silver particles 1 to 6 was evaluated using the method described below. The results are shown in Table 1. As silver particles 7 (average particle diameter 1.88 μm), silver particles from DOWA Electronics Materials Co., Ltd. under the product name AG3-1F were used.

### (Method of Preparing Silver Paste)

The silver particles (1 to 6) were each dispensed into a 50 ml vial, and the silver particles 7 were added to give an equivalent amount of silver. The resulting silver particles were adjusted with diethylene glycol mono-2-ethylhexyl ether to give a silver concentration of 90% by mass and a solvent concentration of 10% by mass to make a total of 100%, to obtain each paste. The paste was kneaded for 30 seconds at 1340/1340 rpm using a rotation/revolution-type kneader (MAZERUSTER KK-400W from Kurabo Industries, Ltd.). Depending on the state of the silver particles and the silver particle dispersion, rough kneading may be performed manually with a spatula or the like. The resulting silver paste was filtered through a mesh with an opening of 100 μm, and a barrel (PSOSN from Iwashita Engineering, Inc.) was charged with 10 g of the paste and sealed. Using the above-mentioned kneader, the barrel charged with the silver paste was stirred and degassed for 60 seconds under the same condition, further stirred, and then allowed to stand for 12 hours. In this way, a sample for flowability test was obtained. The flowability of the silver paste was evaluated using an air pulse-type dispenser (AD3300C from Iwashita Engineering, Inc.). The discharge pressure was adjusted with a regulator to be in the range of 20 to 100 kPa. All the tests were performed using a temperature controller so that the barrel temperature (paste temperature) was adjusted to 25 °C. A precision nozzle with a nozzle diameter of 0.27 mm was mounted to the barrel (PS05N from Iwashita Engineering, Inc.) charged with 10 g of the silver paste, and the barrel was mounted to the dispenser. As a printing condition, the distance from the nozzle tip to the object to be printed (a glass substrate) was set to 100 μm. On the object to be printed, 5-mm line patterns were printed at equal intervals. The printing was set so that one second after the printing of line patterns was completed, next printing of line patterns started. In this way, each time line patterns at 100 points were printed on an object to be printed, the printing moved on to a next object to be printed, and the printing continued for one hour.

### (Discharge Weight Retention Ratio)

Discharge weight retention ratio=B/A*100% by mass was calculated from the weight A of the line patterns (the weight g of the silver paste at 100 points) on the object to be printed at the beginning of printing and the weight B of the line patterns (the weight g of the silver paste at 100 points) on the final object to be printed after the passage of one hour. The discharge weight retention ratio was evaluated as x when the result was less than 50%, evaluated as ◯ when the result was 50% or more, and evaluated as ⊚ when the result was 70% or more.

### (Evaluation of Continuous Printability)

Continuous printability was evaluated as x when the percentage of uncoated portions was 5% or more of all the line patterns discharged in one hour. Continuous printability was evaluated as ◯ when there was no uncoated portion, or the percentage of uncoated portions was less than 5%.

### <Evaluation of Shape Stability>

The shape stability of each of the silver particles 1 to 6 was evaluated using the method described below. The results are shown in Table 1. The shape stability of the silver paste was evaluated by preparing samples as in the flowability test, and using an air pulse-type dispenser (AD3300C from Iwashita Engineering, Inc.). The discharge pressure was adjusted with a regulator to be in the range of 20 to 100 kPa. All the tests were performed using a temperature controller so that the barrel temperature (paste temperature) was adjusted to 25 °C. A precision nozzle with a nozzle diameter of 0.27 mm was mounted to the barrel (PS05N from Iwashita Engineering, Inc.) charged with 10 g of the silver paste, and the barrel was mounted to the dispenser. As a printing condition, the distance from the nozzle tip to the object to be printed (a glass substrate) was set to 100 μm. On the object to be printed, 5-mm line patterns were printed at equal intervals. The printing was set so that one second after the printing of line patterns was completed, next printing of line patterns started. In this way, each time line patterns at 100 points were printed on an object to be printed, the printing moved on to a next object to be printed, and the printing continued for one hour. Shape stability was evaluated as x when visual observation revealed that in all the line patterns discharged in one hour, printed matter in which the silver paste could not be applied in the form of a line and was stringy, or printed matter significantly varying in thickness or fineness was produced in large amounts. Shape stability was evaluated as ◯ when there were only patterns applied in the form of lines, or when there were line patterns having different shapes, but they were not significantly noticeable.

TABLE 1

| | | Comp. Ex. 1 | Ex. 1 | Ex. 2 | Ex. 3 | Ex. 4 | Ex. 5 |
|---|---|---|---|---|---|---|---|
| Silver particles | Primary particle size (nm) | 70 | 70 | 70 | 70 | 515 | 515 |
| | Purification solvent | Methanol | n-Propanol | Isopropanol | 1-Butanol | Methanol | n-Propanol |
| | Surface amine compound | Hexylamine | Hexylamine | Hexylamine | Hexylamine | Hexylamine | Hexylamine |
| | Dispersion solvent | Diethylene | Diethylene | Diethylene | Diethylene | Diethylene | Diethylene |
| | (pasting solvent) | glycol mono- | glycol mono- | glycol mono- | glycol mono- | glycol mono- | glycol mono- |
| | | 2-ethylhexyl | 2-ethylhexyl | 2-ethylhexyl | 2-ethylhexyl | 2-ethylhexyl | 2-ethylhexyl |
| | | ether | ether | ether | ether | ether | ether |
| Photocentrifuge | v10 [μm/s] | 9.37 | 10.76 | 1.047 | 10.41 | 61.08 | 79.78 |
| Method | v50 [μm/s] | 11.6 | 13.56 | 2.793 | 12.76 | 83.46 | 115.2 |
| | v90 [μm/s] | 48.51 | 30.92 | 5.222 | 30.05 | 181.6 | 208.9 |
| | SPAN: (v90 − v10)/v50 | 3.376 | 1.487 | 1.495 | 1.540 | 1.444 | 1.120 |
| Flowability | Discharge weight | 31 | 66 | 74 | 66 | 84 | 65 |
| evaluation | retention ratio (%) | | | | | | |
| | Discharge weight | X | ◯ | ⊚ | ◯ | ⊚ | ◯ |
| | retainability | | | | | | |
| | Continuous printability | X | ◯ | ◯ | ◯ | ◯ | ◯ |

| | | | | | | |
|---|---|---|---|---|---|---|
| Shape stability evaluation | X | ◯ | ◯ | ◯ | ◯ | ◯ |

1. Silver particles dispersed in a solvent, in which
an amine compound is adhered to a surface of the silver particles, and
when a concentration of the silver particles in the solvent is 50% by mass, a value of SPAN as measured by a photocentrifuge method under the following conditions is 0.1 or more and 3.3 or less:
SPAN: (V90−V10)/V50 Equation (1)
wherein when a sedimentation velocity is expressed by a cumulative distribution,
V10 is the sedimentation velocity at a cumulative value of 10%;
V90 is the sedimentation velocity at a cumulative value of 90%; and
V50 (median sedimentation velocity) is the sedimentation velocity at a cumulative value of 50%;
(Measurement Conditions for SPAN)
a measurement sample in which the concentration of the silver particles in the solvent is 50% by mass is prepared; a solvent having an octanol/water partition coefficient (Log Pow) of −2 or more and 4 or less is used as the solvent of the measurement sample; a glass cell (a glass cell with an optical path length of 2 mm) is charged with 0.2 ml of the measurement sample; under a temperature condition of 25 °C, the glass cell is rotated at a low speed at a centrifugal acceleration of 130 G, and data for 500 points are obtained at an interval of 5 seconds, and then the glass cell is rotated at a high speed at a centrifugal acceleration of 1160 G, and data for 500 points are obtained at an interval of 5 seconds; three points between a gas-liquid interface (the liquid surface of the measurement sample) and a solid-liquid interface (the interface between sedimented silver particles and the solvent) of the measurement sample are arbitrarily selected, and each of the three points is analyzed at a node width of 1 mm; each of the sedimentation velocities V90, V10, and V50 is determined from a moving distance of the particles and a time required for the movement, and the SPAN is calculated based on Equation (1).

2. The silver particles according to claim 1, wherein the silver particles have an average particle diameter of 50 to 600 nm.

3. A silver particle dispersion comprising silver particles dispersed in a solvent, in which
an amine compound is adhered to a surface of the silver particles, and
when a concentration of the silver particles in the solvent is 50% by mass, a value of SPAN as measured by a photocentrifuge method under the following conditions is 3.3 or less:
SPAN: (V90−V10)/V50 Equation (1)
wherein when a sedimentation velocity is expressed by a cumulative distribution,
V10 is the sedimentation velocity at a cumulative value of 10%;
V90 is the sedimentation velocity at a cumulative value of 90%; and
V50 (median sedimentation velocity) is the sedimentation velocity at a cumulative value of 50%;
(Measurement Conditions for SPAN)
a measurement sample in which the concentration of the silver particles in the solvent is 50% by mass is prepared; a solvent having an octanol/water partition coefficient (Log Pow) of −2 or more and 4 or less is used as the solvent of the measurement sample; a glass cell (a glass cell with an optical path length of 2 mm) is charged with 0.2 ml of the measurement sample; under a temperature condition of 25 °C, the glass cell is rotated at a low speed at a centrifugal acceleration of 130 G, and data for 500 points are obtained at an interval of 5 seconds, and then the glass cell is rotated at a high speed at a centrifugal acceleration of 1160 G, and data for 500 points are obtained at an interval of 5 seconds; three points between a gas-liquid interface (the liquid surface of the measurement sample) and a solid-liquid interface (the interface between sedimented silver particles and the solvent) of the measurement sample are arbitrarily selected, and each of the three points is analyzed at a node width of 1 mm; each of the sedimentation velocities V90, V10, and V50 is determined from a moving distance of the particles and a time required for the movement, and the SPAN is calculated based on Equation (1).

4. The silver particle dispersion according to claim 3, wherein the silver particles have an average particle diameter of 50 to 600 nm.

5. A conductive adhesive comprising the silver particles according to claim 1.

6. A conductive adhesive comprising the silver particles according to claim 1 and a resin.

7. A sintered body of the conductive adhesive according to claim 5.

8. An electronic part in which members are bonded with the sintered body according to claim 7.

9. A conductive adhesive comprising the silver particles according to claim 2.

10. A conductive adhesive comprising the silver particles according to claim 2 and a resin.
